(19) United States
(12) Patent Application Publication
(10) Pub. No.: US 2004/0159503 A1
(43) Pub. Date: Aug. 19, 2004

(54) Disc brake

(76) Inventor: Chih-Chen Juan, Tainan (TW)

Correspondence Address: BACON & THOMAS, PLLC, 625 SLATERS LANE, FOURTH FLOOR, ALEXANDRIA, VA, 22314

(21) Appl. No.: 10/390,619

(22) Filed: Mar. 19, 2003

(30) Foreign Application Priority Data
Feb. 13, 2003 (TW) 92202320

(51) Int. Cl. B62L 1/00; B62L 3/00; F16D 55/00

(52) U.S. Cl. 188/24.11; 188/71.1

(57) ABSTRACT

A disc brake comprises a base, a disc, two linkages pivoted on the base, wherein the linkages are respectively extended at opposite sides of the disc and along an orientation deviated from a diameter orientation of the disc, two brake blocks mounted on the linkages respectively and facing the disc wherein the brake blocks keep predetermined distances from the disc at initial, and a cable connected to the linkages to move the linkages towards the disc. The linkages serve as a pair of type 2 levers wherein the arm of input (the cable) is larger than the arm of output (the brake block). The linkages, therefore, have mechanical advantages larger than 1 so that less power of the cable input will provide greater power of braking.

### BACKGROUND OF THE INVENTION

1. Field of the Invention

The present invention relates generally to a brake system for vehicle, and more particularly to a disc brake.

2. Description of the Related Art

A conventional disc brake system was usually applied to automobiles or motorcycles. The brake system was driven by hydraulic power to force brake blocks pressing a disc. The system has higher cost so that they are less applied to bicycles.

In the prior art, there were some brake system driven by cables. Such brake system provided a cam mechanism which the cable drives a linkage to turn and brake blocks are therefore forced to displace out and to press a disc via the cam mechanism. A typical conventional cam mechanism consisted of a post and a slot or track in which the post slides and forces the brake blocks pressing the disc. In the other words, the cam mechanism is to transform rotation motion into linear displacement motion.

There always are dusts, sands, water or unknown particles running into the cam mechanism of the conventional brake system while the vehicle runs on street, the cam mechanism, therefore, is east to be locked or rusted. The brake system will not function normal or will reduce the brake efficiency thereof that might cause danger in riding.

### SUMMARY OF THE INVENTION

The primary objective of the present invention is to provide a disc brake, which has a simple structure and is not easy to get malfunction.

According to the objective of the present invention, a disc brake comprises a base, a disc, two linkages pivoted on the base, wherein the linkages are respectively extended at opposite sides of the disc and along an orientation deviated from a diameter orientation of the disc, two brake blocks mounted on the linkages respectively and facing the disc wherein the brake blocks keep predetermined distances from the disc at initial, and a cable connected to the linkages to move the linkages towards the disc.

### BRIEF DESCRIPTION OF THE DRAWINGS

FIG. 1 is an exploded view of a first preferred embodiment of the present invention;

FIG. 2 is a perspective view of the first preferred embodiment of the present invention;

FIG. 3 is a front view of FIG. 2;

FIG. 4 is a lateral view of FIG. 2, showing the linkages located at an initial position where the brake blacks are not in contact which the disc;

FIG. 5 is a lateral view of FIG. 2, showing the linkages turned inwards to force the brake blacks pressing the disc;

FIG. 6 is a perspective view of a second preferred embodiment of the present invention;

FIG. 7 is a perspective view of a third preferred embodiment of the present invention, and

FIG. 8 is a perspective view of a fourth preferred embodiment of the present invention.

### DETAILED DESCRIPTION OF THE INVENTION

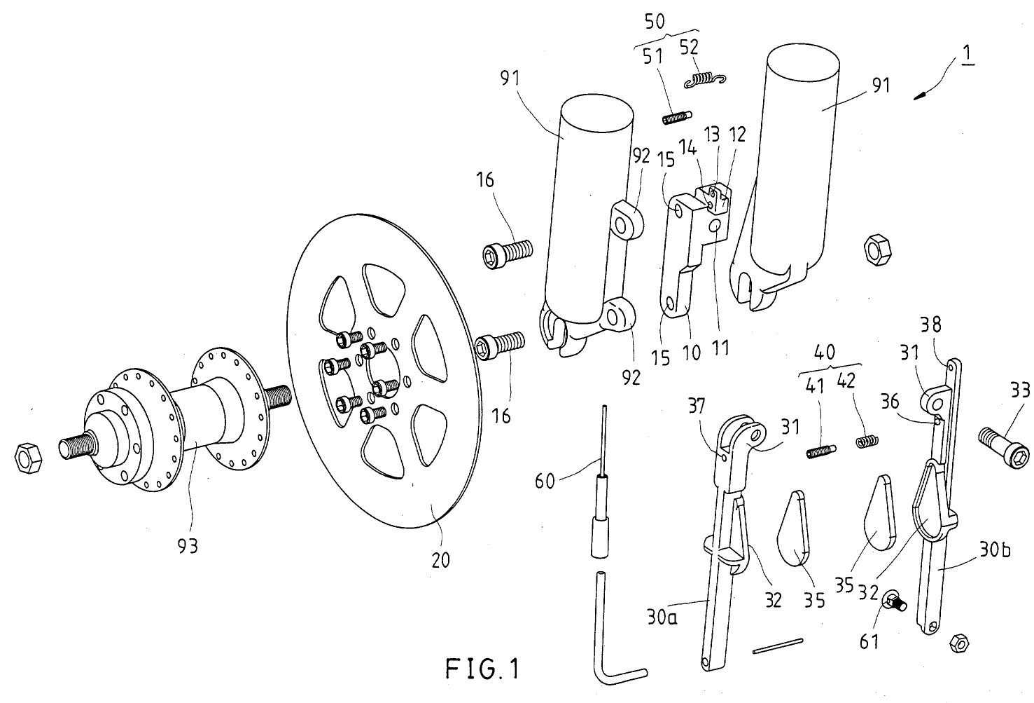

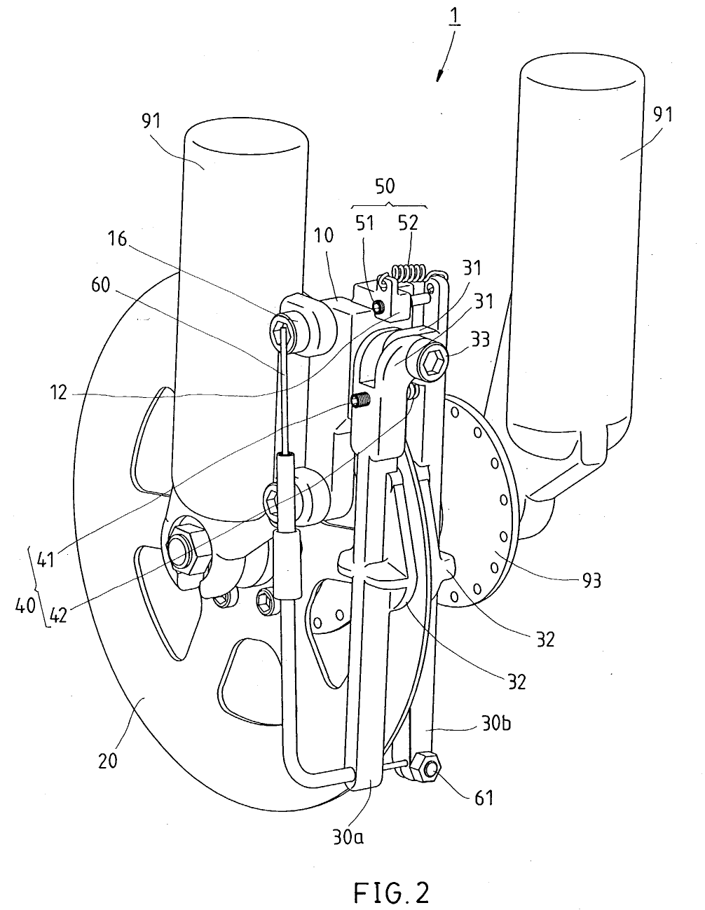

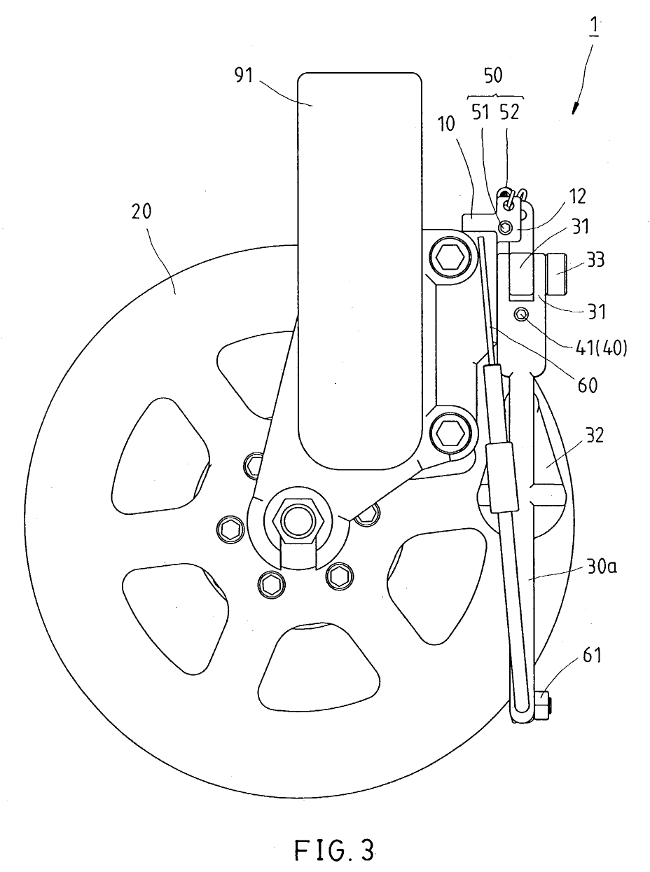

Please refer to FIGS. from FIG. 1 to FIG. 3, a disc brake 1 of the first preferred embodiment of the present invention mainly comprises a base 10, a disc 20, two linkages 30, two brake blocks 35, a tension controller 40, a position controller 50 and a cable 60, wherein

The base has an axle hole 11, a sub-base 12 above the axle hole 11 on which has a hole 13 and a thread hole 14, and two fastening hole 15. The base 15 is secured on a frame fork 91 of a motorcycle or a bicycle via two bolts 16 screwing into the fastening holes 15 of the base 11 and seats 92 on the frame fork 91.

The disc 20 is fixed on a hub 93 of a wheel (not shown) to rotate therewith. The way of how to mount the disc 20 on the hub is a ordinary skill, so I so not describe the detail.

Each linkage 30a and 30b has a pivoting portion 31 at an end thereof and a block mount 32 at a midsection thereof A shaft 33 is inserted into the pivoting portions 31 of the linkages 30a and 30b and the axle hole 11 of the base 10, with that the linkages 30a and 30b are pivoted on the base 10 and have a same center of rotation. The linkages 30a and 30b extend at opposite sides of the disc 20 respectively and cross the disc 20 along an orientation deviated from the diameter orientation of the disc 20. The brake blocks 35 are fixed on the block mounts 32 of the linkage 30a and 30b respectively facing the disc 20. Typically, the blocks 35 are better to be placed at positions deviated from the center of the disc 20 as possible to provide higher brake efficiency.

The tension controller 40 has an adjusting post 41 with a thread thereon and a compression spring 42. The adjusting post 41 is screwed into a thread hole 36 on the linkage 30a at where between the pivot portion 31 and the brake mount 32 and the spring 42 has opposite ends thereof respectively against the other one linkage 30b and the adjusting post 41. The adjusting post 41 is turned to displace forward or backward to change the initial spring force of the spring 42.

The position controller 50 has a position post 51 with a thread thereon and a tensile spring 52. The position post 51 is screwed into the thread hole 14 on the sub-base 12 of the base 10 and the spring 52 has opposite ends thereof respectively hooked to a hole 13 on the sub-base 12 and a hole 38 on the linkage 30b at a section behind the pivot portion 31. The spring 52 forces the linkage 30b turning outwards with the section behind the pivot portion 31 against position post 51 so that the linkages 30a and 30b are turned away from each other with the brake blocks 35 do not in touch with the disc 20 at an initial position. The position post 51 is turned to displace forwards or rearwards to change an angle between the linkages 30a and 30b at the initial position thereof.

The cable 60 has an end thereof connecting to a brake handle (not shown) and the other end thereof running through a hole at an end of the linkage 30a distal from the pivot portion 31 and secured to the other linkage 30b with a bolt 61. The brake handle is pressed to move the linkages 30a and 30b toward the disc 20 and force the brake blocks 35 pressing the disc 20.

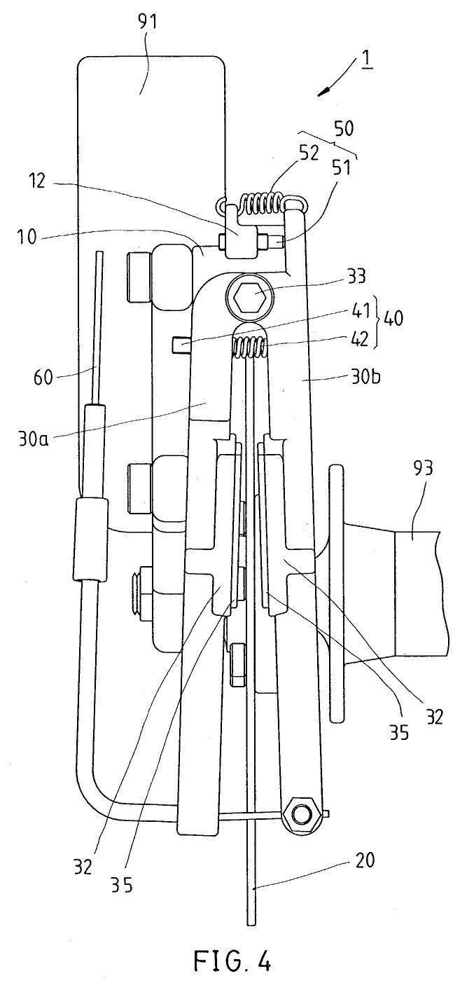

At initial, as shown in FIG. 4, the cable 30 does not draw the linkages 30a and 30b. The position controller 50 will keep the linkages 30a and 30b opened a suitable angle for the brake blocks 35 not in touch with the disc 20.

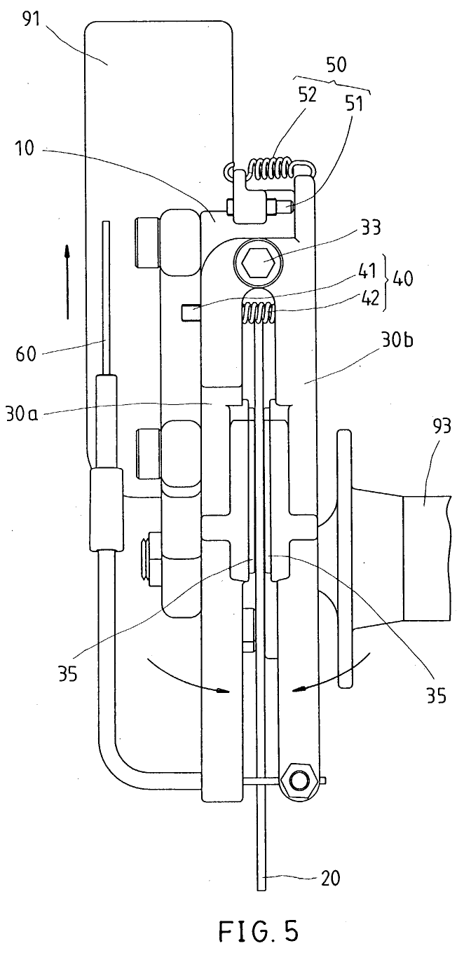

The brake handle is pressed to make the cable 60 drawing the linkages 30a and 30b inwards as shown in FIG. 5. The brake blocks 35 are pressing the disc 20 in such condition to provide braking function.

The linkages 30a and 30b serve as a pair of type 2 levers, wherein the outputs (the brake blocks 35) are at middle and the fulcrums (the pivot portions 31) and the inputs (points at where the cable 60 is connected to) are at opposite sides. The mechanical advantages of the levers are greater than 1, which means less tension of the cable 60 can generate larger braking function.

The cable 60 must overcome the spring force of the spring 42 of the tension controller 40 while the linkages 30a and 30b are drawn inwards. The adjusting post 41 is turned forwards to compress the spring 42 such that the cable 60 must provide more tension to draw the linkages 30a and 30b. On the contrary, the adjusting post 41 is turned forwards to loose the spring 42 such that the cable 60 provides less tension to draw the linkages 30a and 30b.

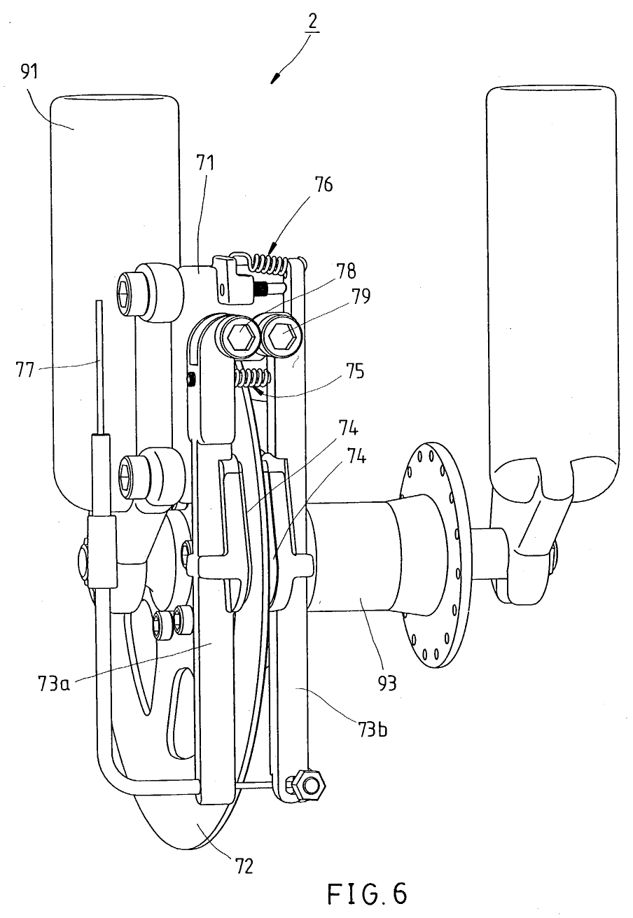

FIG. 6 is a disc brake 2 of the second preferred embodiment of the present invention, which is similar to the first preferred embodiment, comprising a base 71, a disc 72, two linkages 73a and 73b, two brake blocks 74, a position controller 75, a tension controller 76 and a cable 77. The disc brake 2 of the second preferred embodiment is similar to the disc brake 1 of the first preferred embodiment except that the linkages 73a and 73b have two independent centers of rotation 78 and 79 and are arranged in horizontal. The reason of the linkages 73a and 73b having independent centers of rotation 78 and 79 is that the linkages 73b is moved toward the disc 72 and in touch with it first, and then the linkage 73a is moved toward the disc 72. The motions of the linkages 73a and 73b are different while the cable 77 draws them to move inwards. The linkages 73a and 73b will have independent motions while they have their own centers of rotation 78 and 79 such that the tracks of the linkages 73a and 73b moving and the position and time of the linkages 73a and 73b touching the disc 20 are easy to be controlled precisely.

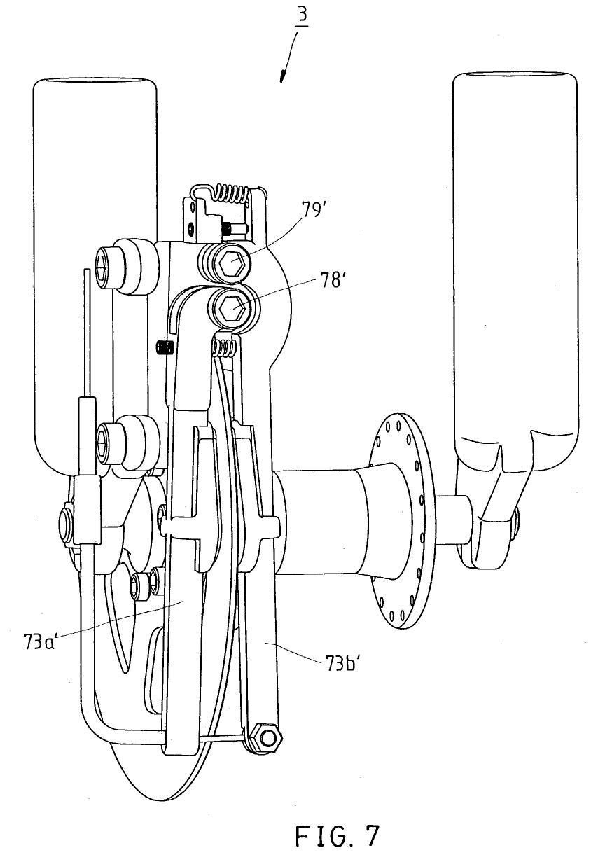

FIG. 7 is a disc brake 3 of the third preferred embodiment of the present invention, which is similar to the disc brake 2 of the second preferred embodiment, except that two linkages 73a′ and 73b′ have independent centers of rotation in vertical.

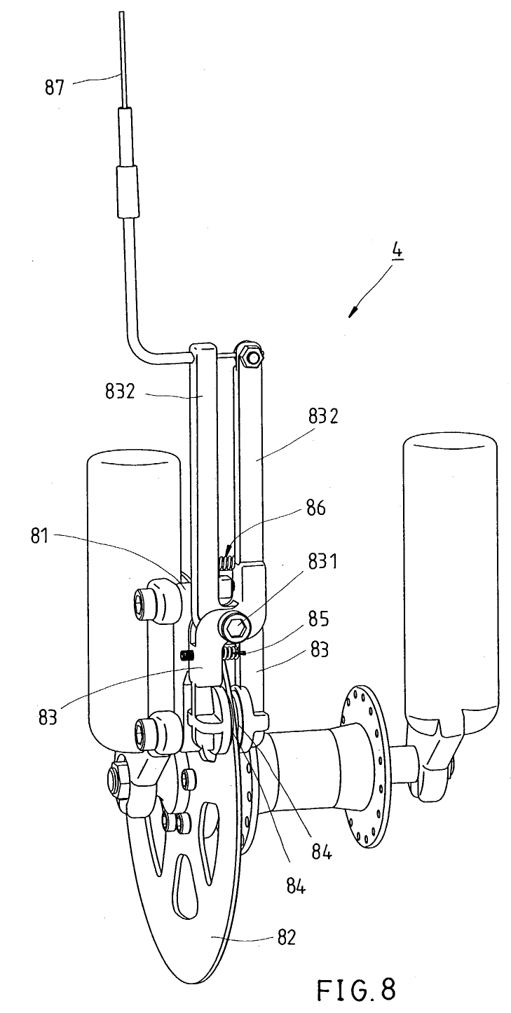

FIG. 8 is a disc brake 4 of the fourth preferred embodiment of the present invention comprising a base 81, a disc 82, two linkages 83a and 83b, two brake blocks 84, a position controller 85, a tension controller 86 and a cable 87. Each linkage 83a and 83b has an arm 832 extended rearward from a pivot portion 831. The cable 87 is connected with distal ends of the arms 832 of the linkages 83a and 83b to make the linkages 83a and 83b serving as a pair of type 1 levers, wherein the fulcrums (the pivot portions 831) are at middle and the inputs (points at where the cable 87 is connected to) and the outputs (the brake blocks 84) are at opposite sides. The mechanical advantages of the levers depend on the ratio of the lengths of the linkages 83a and 83b and the arms 832.

What is claimed is:

1. A disc brake, comprising:
a base mounted on a vehicle;
a disc mounted on a hub of a wheel of the vehicle;
two linkages pivoted on the base, wherein the linkages are respectively extended at opposite sides of the disc and along an orientation deviated from a diameter orientation of the disc;
two brake blocks mounted on the linkages respectively and facing the disc wherein the brake blocks keep predetermined distances from the disc at initial, and
a cable connected to the linkages to move the linkages towards the disc.

2. The disc brake as defined in claim 1, wherein the linkages cross the disc with the brake blocks at middles and the points at wherein the linkages are pivoted on the base and points at where the cable is connected to are at opposite sides.

3. The disc brake as defined in claim 1, wherein the linkages each has a point at where the linkage is pivoted on the base at middle and the brake blocks and a point at where the cable is connected to at opposite sides.

4. The disc brake as defined in claim 1, wherein a shaft is inserted into the linkages to pivot them on the base such that both of the linkage have a single center of rotation.

5. The disc brake as defined in claim 1, wherein two shaft are inserted into the linkages respectively to pivot them on the base such that the linkage have two independent centers of rotation.

6. The disc brake as defined in claim 5, wherein the centers of rotation of the linkages are arranged in horizontal.

7. The disc brake as defined in claim 5, wherein the centers of rotation of the linkages are arranged in vertical.

8. The disc brake as defined in claim 1, further comprising a position controller having a post and a spring wherein the spring exerted on at least one of the linkage to make the linkage against the post at initial.

9. The disc brake as defined in claim 8, wherein the post is movably provided on the base.

10. The disc brake as defined in claim 1, further comprising an adjusting controller having a spring with opposite ends against the linkages respectively.

11. The adjustable wrench as defined in claim 1, further comprising an adjusting controller having a post and a spring, wherein the post is movably mounted on one of the linkage and the spring have opposite ends against an and of the post and the other linkage.
